(19) United States
(12) Patent Application Publication
(10) Pub. No.: US 2012/0102978 A1
(43) Pub. Date: May 3, 2012

(54) LIQUEFIED NATURAL GAS REFUELING SYSTEM

(76) Inventors: Ron C. Lee, Bloomsbury, NJ (US); Philippe Heisch, Huningue (FR)

(21) Appl. No.: 13/102,242

(22) Filed: May 6, 2011

Related U.S. Application Data
(60) Provisional application No. 61/351,028, filed on Jun. 3, 2010.

(51) Int. Cl. F17C 7/02

(52) U.S. Cl. 62/50.1

(57) ABSTRACT

A method and apparatus for supplying liquefied natural gas to a storage tank or a fuel tank at specified temperatures and pressures. The method employs the steps of pressurizing a conditioning vessel with gaseous natural gas at a first pressure, feeding liquefied natural gas at a second pressure greater than the first pressure to a condenser in heat transfer relationship with the conditioning vessel, and withdrawing the liquefied natural gas from the condenser.

### CROSS REFERENCE TO RELATED APPLICATIONS

This application claims priority from U.S. patent application Ser. No. 61/351,028 filed Jun. 3, 2010.

### BACKGROUND OF THE INVENTION

The invention provides for a method and apparatus to supply liquefied natural gas at a specified but adjustable temperature and pressure. More particularly, the invention is particularly useful for refueling onboard vehicle fuel tanks.

Liquefied natural gas (LNG) is composed primarily of methane, which comprises about 85 to 99% of the natural gas on a molar basis. Lesser components that may be present include ethane, propane, carbon dioxide, oxygen and nitrogen. For the purposes of illustration, the properties of pure methane will be used to characterize LNG.

LNG vehicle fuel tanks typically require a minimum storage pressure of about 6-10 barg in order to deliver the fuel to the engine without the assistance of a pump. This minimum pressure has proven difficult to maintain because LNG in a bulk storage tank has a temperature which may be well below the saturation temperature at the desired onboard fuel tank pressure (i.e., subcooled). There are standard pressure building methods to maintain elevated pressures in stationary and bulk cryogenic storage vessels, independent of the degree of subcooling of the bulk of the liquid. However, in a typically horizontal, relatively small, and constantly moving onboard fuel tank, the subcooled liquid will thwart standard pressure building methods. This is because the subcooled liquid will be constantly brought into contact with the vapor space in the tank to condense any superheated vapor.

For example, at 6.5 bara the saturation temperature is about −133° C. However, the liquid from the bulk storage tank is filled from bulk road transport containers at temperatures as low as about −150° C. This cold supply liquid to a refueling system is persistent and despite raising the pressure of the liquid (either in the bulk storage tank, or through the action of a pump) the temperature will remain subcooled relative to the desired saturation temperature. The solution to this problem has typically been to ‘saturate’ the liquid in the bulk storage tank to a desired pressure and temperature. U.S. Pat. No. 5,682,750 is typical of this type of solution. A portion of the bulk storage liquid is removed from the storage tank, pressurized with a pump, passed through a heat exchanger where it is vaporized, and re-introduced into the bottom of the storage tank where it will warm and mix the contents. This procedure continues until the desired temperature and pressure of the bulk storage tank is achieved.

The bulk tank ‘saturation’ method does have drawbacks. It is a relatively expensive and time consuming technique that requires a non-standard operation of a bulk cryogenic storage tank. Other serious problems are that it introduces inflexibility into the refueling system operation and increases the likelihood that excess pressure natural gas will be vented from the bulk storage tank. The ‘saturation’ step will produce a particular temperature and pressure which may be suitable for only one type of onboard fuel tank. Other onboard tanks may require a different temperature and pressure, or may rely on self pressurization through the use of an onboard pump or compressor. For the latter situation, the ‘saturation’ step is not only unnecessary, but it is detrimental to the density of the LNG inside the onboard fuel tank, as well as the amount of time the LNG can be stored in the onboard fuel tank without venting. To accommodate the dual requirements of some onboard tanks needing saturated liquid, while others preferring subcooled liquid, some refueling stations must have two bulk storage tanks. This added cost and complexity is necessary so that one bulk storage tank is ‘saturated’ as described above, while the other is maintained as subcooled as possible.

Further, even in the case of an onboard fuel tank that must maintain an elevated pressure, it is generally advantageous to first introduce subcooled LNG in order to collapse the existing gas in the fuel tank and/or pre-cool the tank. Finally, the U.S. Pat. No. 6,354,088 attempts to address the difficulties with the bulk ‘saturation’ approach by introducing an external heat exchanger and mixing arrangement which can be adjusted to produce LNG of arbitrary temperature through a predictive control algorithm. The system of the '088 patent also has a number of complexities that would make it impractical for stable control during the highly transient operation of a refueling system.

### SUMMARY OF THE INVENTION

In one embodiment of the invention, there is disclosed a method for producing liquefied natural gas at selected pressures and temperatures comprising the steps of pressurizing a conditioning vessel containing a condenser with natural gas at a first pressure; feeding liquefied natural gas at a second pressure to the condenser; and withdrawing the liquefied natural gas from the condenser.

The second pressure is higher than the first pressure. The natural gas at a first pressure and liquefied natural gas at a second pressure are fed from a bulk storage container.

The condenser is in heat transfer relationship and is present within the conditioning vessel. Both the condenser and the conditioning vessel are fluidly connected to the bulk storage continuer holding the liquefied natural gas as the conditioning vessel is in communication with a vapor region of the bulk storage tank and the condenser is in communication with a liquid region of the bulk storage tank. The conditioning vessel thus contains both natural gas and liquefied natural gas. The liquefied natural gas, when it is withdrawn from the condenser is at a higher temperature than when it is originally fed to the condenser from the bulk storage tank.

The maximum bulk storage tank pressure is preferably maintained by routing a portion of the subcooled liquefied natural gas liquid into the vapor region of the bulk storage tank. More than one bulk storage tank may be employed and the more than one bulk storage tank may be operated at different pressures from each other.

In an alternative embodiment the bulk storage tank may be maintained at a third pressure that is also greater than the first pressure. The first pressure is maintained through a series of valves in fluid communication with the bulk storage tank at said third pressure.

In another embodiment of the invention there is disclosed an apparatus comprising a bulk storage tank fluidly connected to a condenser which is in a heat transfer relationship with a conditioning vessel. The bulk storage tank contains a liquid cryogen such as liquefied natural gas. The bulk storage tank is fluidly connected to the conditioning vessel as well and the condenser is contained within the conditioning vessel.

Both the bulk storage tank and the conditioning vessel are in fluid communication with a heat exchanger. The liquid portion inside the bulk storage tank is in fluid communication with the condenser and the gaseous portion inside of the bulk storage tank is in fluid communication with the conditioning vessel.

The present invention is a method for producing liquefied natural gas at user specified pressures and temperatures. It comprises the steps of pressurizing a conditioning vessel with gaseous natural gas at a first pressure, feeding liquefied natural gas at a second pressure greater than the first pressure to a condenser in heat transfer relationship with the conditioning vessel, and withdrawing the liquefied natural gas from the condenser.

In a preferred embodiment, the conditioning vessel is fluidly connected to the vapor region of a bulk storage tank holding the liquefied natural gas at a first pressure. The conditioning vessel is also fluidly connected to a heating element. Liquefied natural gas from the bulk storage container is pressurized to a second pressure by a pump and enters the condenser. This causes a portion of the vapor in the conditioning vessel to condense forming a liquid. This liquid is fed to the heating element where it will vaporize and be fed to the line connecting the conditioning vessel with the vapor region of the bulk storage tank. Gas generated by the heating element will replace the gas condensed in the conditioning vessel. The line connecting the conditioning vessel with the vapor region of the bulk storage tank ensures the pressure within the conditioning vessel will remain substantially unchanged at the first pressure.

Sometimes the customer may desire the liquefied natural gas at a temperature roughly the same as the subcooled liquid temperature in the bulk storage tank. The liquefied natural gas from the tank, after being optionally pressurized to a second pressure by a pump, may bypass the condenser and be fed directly to a customer's tank.

Alternatively, the bulk storage tank may be maintained at a third pressure greater than the first pressure. The line connecting the conditioning vessel and vapor region of the bulk storage tank will contain appropriate valves or series of valves to maintain the first pressure within the conditioning vessel.

The minimum pressure of the bulk storage tank is maintained by the action of a normal pressure building circuit familiar to those skilled in the art. The pressure building circuit may be optionally controlled by a valve arrangement that periodically interrupts the operation of the circuit during at least a portion of the refueling operation when an excess of vapor is temporarily produced within the conditioning vessel. The maximum pressure within the bulk storage tank may be maintained through the act of venting vapor, but is preferably maintained by routing at least a portion of subcooled liquid at a second pressure (generally through the action of a pump) into the vapor region of the bulk storage tank. This subcooled liquid will cause condensation of the vapor in the top of the bulk storage tank and a reduction of tank pressure. The present invention increases the availability of subcooled liquid, and therefore the necessity to vent vapor because of excess pressure, by the avoidance of the bulk tank ‘saturation’ process.

The invention also provides for an apparatus for delivering liquefied natural gas to a fuel tank comprising a liquefied natural gas storage tank in fluid communication with a conditioning vessel that contains a condensing heat exchanger wherein said condenser is in fluid communication with said storage tank and said fuel tank.

The invention can be used to thermodynamically condition a variety of volatile fluids besides liquefied natural gas, including cryogenic fluids selected from the group consisting of nitrogen, oxygen, argon, ethylene and mixtures thereof, as well as other volatile fluids.

Additional control elements, valves, pumps and other components may be added to the system to supplement or replace the examples shown. Additional elements may be included to operate the bulk storage tank, including standard pressure building, refueling, venting, loading and similar operations.

Multiple bulk storage tanks may be used and operated at various pressures. Methods for thermodynamic control of the bulk storage tank, such as “saturation” methods may be employed.

The refueling arrangement where refueling is direct to the customer's storage tanks or to the vehicle fuel tanks may employ multiple additional elements for efficient operation. Pressure and flow control logic may be employed to signal when the refueling operation is complete. Additional piping may be employed to route at least a portion of the excess gas that may be present at the beginning of the refueling, or produced during refueling, back to the bulk storage tank.

Suitable thermal protection is envisioned for all of the cryogenic elements of the system. This may be foam or vacuum insulation. Additionally, the pumps and/or conditioning vessel may be placed inside another vessel containing LNG.

### BRIEF DESCRIPTION OF THE DRAWINGS

FIG. 1 is a schematic of a liquefied natural gas refueling system according to the invention.

FIG. 2 is a different schematic of a liquefied natural gas refueling system according to the invention.

### DETAILED DESCRIPTION OF THE INVENTION

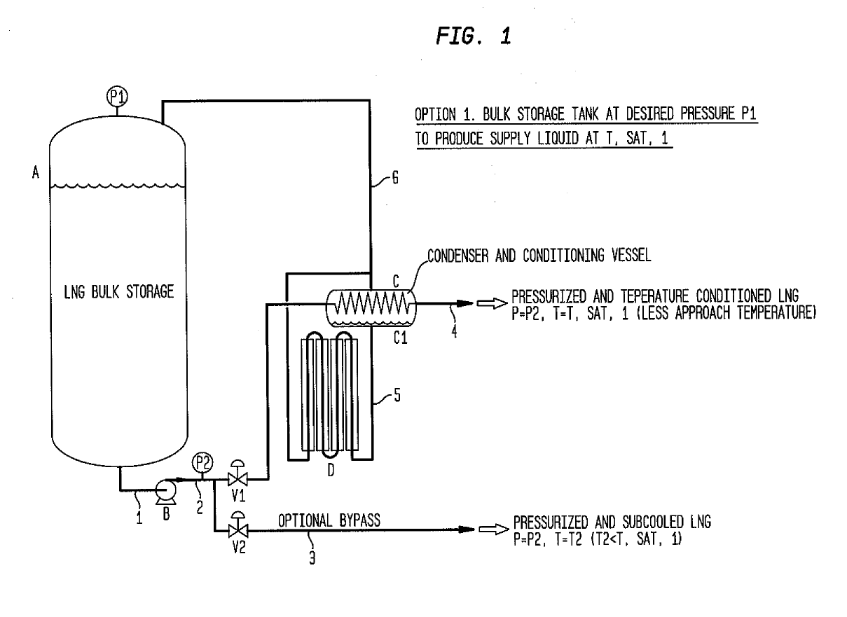

The invention provides an inherently stable, and quickly adjustable, method for producing LNG at specified temperatures and pressures. In one embodiment, detailed in FIG. 1, a LNG distribution system is shown. The bulk storage tank A is maintained at pressure P1 through standard tank pressure control methods, not shown in the figure. The pressure P1 may vary somewhat over time in order to minimize unnecessary venting of natural gas vapor. A typical bulk storage tank pressure is about 4 to 12 barg. The liquefied natural gas will exit the bulk storage tank A through line 1 and pump B. The liquefied natural gas now at pressure P2 which is higher than pressure P1 passes through valve V1 by line 2 and into condenser C which is in a heat transfer relationship with conditioning vessel C1. The liquefied natural gas will exit the condenser C through line 4 at the pressure P2 and at a temperature that is higher than the temperature before it entered the condenser C. This exit temperature will be substantially equal to, but slightly colder than, the saturation temperature of natural gas at a pressure P1.

The inside of the conditioning vessel C1 contains both natural gas and liquefied natural gas. The liquefied natural gas from line 2 will enter condenser C and vapor in the condenser C will condense and form liquid. The condensed liquid will be fed to heating element D through line 5 where it will vaporize and be fed to line 6 where it will be fed to the liquefied natural gas bulk storage tank A and conditioning vessel C1. Suitable heating elements include ambient vaporizers, and electric or steam vaporizers that are well known in the art. Line 6 will ensure that the pressure in conditioning vessel C1 will remain at substantially pressure P1. Gas that is produced by the heating element D will, on a time averaged basis, replace that which is condensed in conditioning vessel C1.

In the event the customer wants the liquefied natural gas delivered at a temperature about the same as the subcooled liquid temperature of bulk storage tank A, the liquefied natural gas will also exit the tank A through line 1 and through pump B. Valve V1 will be closed and line 2 will feed the liquefied natural gas through valve V2 and line 3 directly to the customer's tank (not shown).

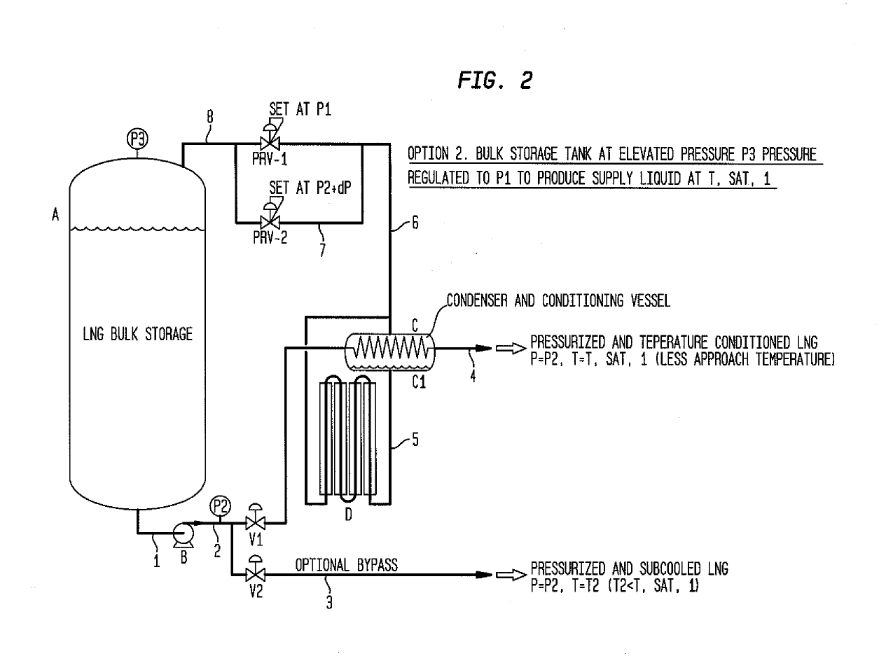

In FIG. 2, the same elements are labeled with the same designations as in FIG. 1. In this embodiment, the pressure inside the bulk storage tank A is maintained at a third pressure P3 greater than P1. The line 6 connecting the conditioning vessel C1 and the vapor region of the bulk storage tank A contains a valve or series of valves to maintain the first pressure P1 within the conditioning vessel C1.

Pressure regulating valve PRV-1 will provide vapor from the bulk storage tank to condensing vessel C1 in an amount necessary to maintain a minimum pressure P1. In the event the pressure in the condensing vessel significantly exceeds the pressure P1, which may occur for short periods of time when vapor produced by heater D does not exactly match the vapor condensed in vessel C1, then pressure regulating valve PRV-2 will return vapor from condensing vessel C1 in an amount necessary to maintain a maximum pressure no greater than the bulk tank pressure P3. Alternative methods for reducing the pressure in the conditioning vessel C1 are possible. For example, other valve arrangements, not shown, could also vent a portion of the excess pressure in condensing vessel C1 to the atmosphere to maintain a maximum pressure close to P1.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

1. A method for producing a cryogenic liquid at selected pressures and temperatures comprising the steps of pressurizing a conditioning vessel containing a condenser with cryogenic gas at a first pressure; feeding cryogenic liquid at a second pressure to said condenser; and withdrawing the cryogenic liquid from the condenser.

2. The method of claim 1 where the cryogenic liquid is selected from the group consisting of natural gas, nitrogen, oxygen, argon, ethylene and mixtures thereof.

3. The method of claim 1 where the cryogenic liquid is natural gas.

4. The method of claim 1 where the cryogenic gas is the vaporized form of said cryogenic liquid

5. The method as claimed in claim 1 wherein the second pressure is higher than the first pressure.

6. The method as claimed in claim 1 wherein said cryogenic gas at a first pressure and cryogenic liquid at a second pressure are fed from a bulk storage container.

7. The method as claimed in claim 1 wherein said condenser is in heat transfer relationship with the conditioning vessel.

8. The method as claimed in claim 6 wherein said condenser and conditioning vessel are fluidly connected to said bulk storage container holding said liquefied natural gas.

9. The method as claimed in claim 8 wherein said conditioning vessel is in communication with a vapor region of said bulk storage tank.

10. The method as claimed in claim 9 wherein said condenser is in communication with a liquid region of said bulk storage vessel.

11. The method as claimed in claim 1 wherein pressure in said bulk storage tank is maintained at a maximum pressure by routing a portion of subcooled liquid into a vapor region of said bulk storage tank.

12. The method as claimed in claim 1 comprising more than one bulk storage tank.

13. The method as claimed in claim 12 wherein said more than one bulk storage tank is operated at different pressures.

14. The method as claimed in claim 1 wherein the cryogenic liquid is at a higher temperature when withdrawn from said condenser.

15. The method as claimed in claim 1 wherein said conditioning vessel contains both cryogenic gas and cryogenic liquid.

16. The method as claimed in claim 1 wherein said bulk storage tank is maintained at a third pressure greater than the first pressure.

17. The method as claimed in claim 16 wherein said first pressure is maintained through a series of valves in fluid communication with said bulk storage tank at said third pressure.

18. An apparatus comprising a bulk storage tank fluidly connected to a condenser which is in a heat transfer relationship with a conditioning vessel.

19. The apparatus as claimed in claim 18 wherein said bulk storage tank is for containing a liquid cryogen.

20. The apparatus as claimed in claim 19 wherein said liquid cryogen is selected from the group consisting of natural gas, nitrogen, oxygen, argon, ethylene and mixtures thereof.

21. The apparatus as claimed in claim 18 wherein said bulk storage tank is fluidly connected to said conditioning vessel.

22. The apparatus as claimed in claim 18 wherein said condenser is contained inside of said conditioning vessel.

23. The apparatus as claimed in claim 18 wherein said bulk storage tank is in fluid communication with a heat exchanger.

24. The apparatus as claimed in claim 18 wherein said conditioning vessel is in fluid communication with a heat exchanger.

25. The apparatus as claimed in claim 18 wherein a liquid portion inside of said bulk storage tank is in fluid communication with said condenser.

26. The apparatus as claimed in claim 18 wherein a gaseous portion inside of said bulk storage tank is in fluid communication with said conditioning vessel.
